(19) United States
(12) Patent Application Publication
(10) Pub. No.: US 2007/0188474 A1
(43) Pub. Date: Aug. 16, 2007

(54) Touch-sensitive motion device

(76) Inventor: Philippe Stanislas Zaborowski, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/431,540

(22) Filed: May 11, 2006

Related U.S. Application Data
(60) Provisional application No. 60/773,628, filed on Feb. 16, 2006.
(60) Provisional application No. 60/773,629, filed on Feb. 16, 2006.

(51) Int. Cl. G06F 3/041

(52) U.S. Cl. 345/173

(57) ABSTRACT

A method of entering data to an electronic device is outlined using a modified touch-pad. The touch-pad is modified to include the addition of surface features, which provide distinguishable tactile feedback to the user allowing improved spatial resolution of the positioning of an object onto the surface of the touch-pad. In this manner the touch-pad allows the user to select from multiple positions across the surface of the touch-pad, the outcomes of each position being optionally different, such as alphanumeric character selection

This application claims benefit from U.S. Provisional Patent Application No. 60/773,628 filed Feb. 16, 2006, and U.S. Provisional Patent Application No. 60/773,629 filed Feb. 16, 2006, the entire contents of which is incorporated herein by reference.

### FIELD OF THE INVENTION

The invention relates to the field of touch-sensitive motion devices for electronic devices.

### BACKGROUND OF THE INVENTION

The wide variety of consumer electronics devices available today such as, home computers, laptop computers, cellular telephones, personal data assistants (PDA) and personal music devices such as MP3 players, rely upon microprocessors. Advances in the technology associated with microprocessors have made these devices less expensive to produce while improving their quality and increasing their functionality. Despite the improvements in microprocessors the physical user interfaces that these devices use have remained relatively unchanged over the years. Thus, while it is not uncommon for a home computer to have a wireless keyboard and mouse, the keyboard and mouse are quite similar to keyboards and mice commonly available a decade ago.

Cellular telephones and PDAs rely upon keypads that are functionally similar to those of analogous devices used many years ago. As the functions that PDAs support are now relatively complex the keypads that they support increasing have more keys. This represents a design constraint as the size of individual PDAs is reduced while the number of keys increases to the extent that users of these devices often have difficulty pressing desired keys on the keypad without pressing undesired keys. In some cases, the designers of cellular telephones have avoided this problem by limiting the number of keys on the keypad while associating specific characters with the pressing of a combination of keys. Due to its complexity, this solution is difficult for many users to learn and use.

In many instances the keypad and keyboard solutions for entering data are impossible for the user to access either through disabilities which can include visual impairment, motion impairment, or simply protective equipment for the environment they are working in.

The touch-pad, in the past decade has become common to laptops and palmtops as a means of removing the requirement for a separate mouse, such that motion of the users finger provides for motion across the screen and a single tap selects a predetermined function. In laptops and palmtops this feature allowing the user to move the cursor without the need for a physical supporting surface for a mouse, or adding a tracker ball or other element to the computer.

As originally contemplated, and subsequently implemented, for example in 1994 by Gerpheide (U.S. Pat. No. 5,305,017), and in 1995 by Boie et al (U.S. Pat. No. 5,463,388), the touch-pad is based upon the use of thin film materials to provide a means to detect a localized change in the electrical characteristics of the distributed electrical surface. As such the touch-pad allows for a user to provide control input signals based solely upon the motion of a users finger allowing the touch-pad to be easily deployed as a replacement for the computer mouse.

There has been relatively limited development of the touch-pad further in terms of capabilities and functionality. Amongst the limited development has been that of Holehan (U.S. Pat. No. 5,887,995) and Manser et al (U.S. Pat. No. 6,388,660). Holehan discloses the merging of a typical calculator or telephone keypad with a touch-pad, and as such presents a device wherein the traditional array of electrical contacts, one per key, is replaced with a touch-pad. However, the upper surface is now essentially the same flexible molded multiple key surfaces as seen on calculators and telephones. Manser takes the concept one step further by allowing for multiple membranes to be placed over the touch pad allowing the functionality to be adjusted from say calculator to mouse.

However, these require additional elements above and beyond the touch-pad, and are generally are designed to replicate traditional entry formats such as calculator keypads, and to be presented in a form and position typical of today's computer deployed touch-pads. A decade of development still offers us small flat rectangular touch-pads on a laptop with simple motion and single tap differentiation. It would therefore be advantageous to provide an interface for an electronic device which not only provided for a dynamic allocation of function, so that it can perform as numeric keypad, text keypad, pointing device and switch for example, but did so in a manner that facilities the integration of such a device into any small, lightweight and inexpensive electronic device.

### SUMMARY OF INVENTION

In accordance with the invention there is provided an apparatus for providing data input signals to an electronic device. The data input signals being derived from a pad, the pad for receiving a user selected input signal, the pad also having at least a surface element being part of the surface of the pad, the surface element providing a distinguishable feedback to the user. The pad generating the data input signal in response to the user input signal; the user input signal being at least an object's position in relation to the surface of the pad; wherein the object is controlled by a user.

### BRIEF DESCRIPTION OF THE DRAWINGS

Exemplary embodiments of the invention will now be described in conjunction with the following drawings, in which:

FIG. 1A illustrates a typical prior art touch-pad for providing cursor motion;

FIG. 1B illustrates the typical prior art interface from the touch-pad and finger to the electronic device digital control signals;

FIG. 2A illustrates a typical prior art laptop with touch-pad and numeric keys as part of one row of keyboard;

FIG. 2B illustrates a typical prior art numeric overlay for a touchpad;

FIG. 2C illustrates a cross-section of a prior art pressure contacting overlay for a touchpad;

FIG. 3 illustrates a first embodiment of the invention wherein the touch-pad includes a single surface feature;

FIG. 4A illustrates a second embodiment of the invention wherein the touch-pad includes several surface features;

FIG. 4B illustrates the finger motion for a user entering an upper-case “S” into the electronic device via motion on the keypad of FIG. 4;

FIG. 4C illustrates the finger motion for a user entering a lower-case “s” into the electronic device via motion on the keypad of FIG. 4; and,

FIG. 5 illustrates a third embodiment of the invention wherein three touch-pads are provided, one of which having surface features.

### DETAILED DESCRIPTION OF EMBODIMENTS OF THE INVENTION

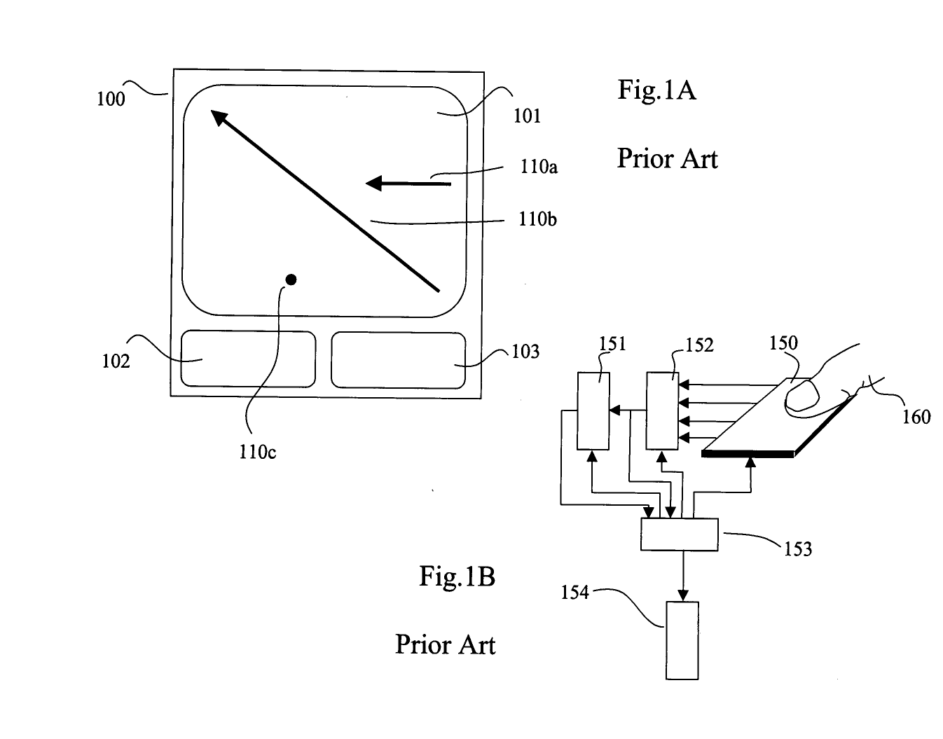

FIG. 1A illustrates a typical prior art touch-pad for receiving a user input signal in the form of a single function selection from a tap motion. As such the figure depicts a touch-pad typically encountered by today's user on laptop computers and palm-top computers.

Shown is a touch-pad element 100 which would be part of the top-keyboard surface of a computer. The touch-pad typically comprising touch-pad surface 101 and two buttons 102 and 103. Buttons 102 and 103 are typically enabled to replace the buttons on a typical computer mouse.

Touch-pad sensors integrated into the touch-pad surface 101 detect contact of the users finger. This contact is used to determine a relative motion of the user's finger, such as: a short lateral stroke 110a, a large directional motion 110b, or a tap 110c. According to the application currently loaded on the computer and the previous series of entered keystrokes the touch-pad actions 110a to 110c can have different results on the action undertaken by the computer.

FIG. 1B illustrates the typical prior art interface from the touch-pad and finger to the electronic device digital control signals. As shown the users finger 160 is in contact with a touch-pad 150. The touch-pad surface 150 having a plurality of electrical contacts which are interfaced to an electrical balance circuit 152, such that the position of the user's finger 160 onto the touch-pad surface 150 results in a change in the electrical balance of several contacts fed to the electrical balance circuit 152.

The output port of the electrical balance circuit 152 is electrically coupled to a balance ratio determination circuit 151 and control circuit 153. The balance ratio determination circuit 151 provides for establishing the relative position of the finger within the activated segment of the touch-pad surface 150. The control circuit 153, therefore, determines the position and motion of the conductive “point” allowing the distinction of the motions and actions 110a to 110c of FIG. 1A. The output port of the control circuit 153 is then coupled to a utilization circuit 154, which provides the positional and directional information determined by the control circuit 153 to the electronic device within which the touch-pad is integrated or attached (not shown for clarity).

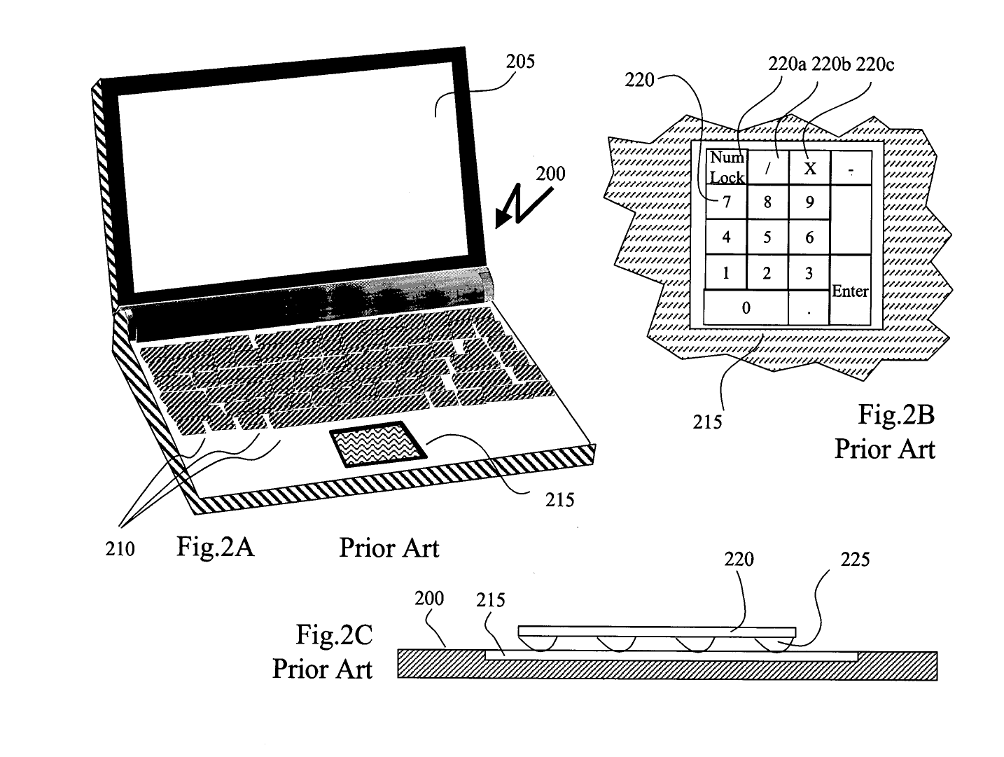

FIG. 2A illustrates a typical prior art laptop computer 200 with touch-pad 215 and alphanumeric keys 210. Shown is a laptop computer 200, which presents information to a user through the screen 205. User selected input information is normally entered via the alphanumeric keys 210, which are provided in typical laptop computers for entry of text characters and common punctuation marks as well as functions such as home, end, and tab. Typically the numeric keys 0-9 are displayed as a single row within the keyboard keys 210 on laptops and palmtops as the demand is for smallest footprint of the machine with ease of use of the user. The additional functions of plus (+), minus (−), equals (=) being combinations of direct single key and dual-key entries, the decimal point being the normal period keystroke (.), which is generally three rows displaced from the numeric keys. The result is entry of numeric data in a format that is not normally associated by a user with such entry via a calculator keyboard or the keyboard of a desktop computer, which due to relaxed space requirements, has a keypad located additionally.

In FIG. 2A the touch-pad 215 presents, as shown, the normal functions of replacing external peripheral devices such as mouse or tracker-ball allowing the user to move the cursor rapidly around the screen.

FIG. 2B illustrates a typical prior art numeric overlay for a touch-pad 215. Here a keypad membrane 220 has been placed over the touch-pad surface 215. The keypad membrane 220, as shown in this exemplary embodiment, is a numeric keypad as commonly found on a calculator. The keypad membrane 220 is printed to mimic the keys of a typical calculator such as shown by membrane keys 220a to 220c.

FIG. 2C illustrates a cross-section of a prior art keypad membrane 220 overlay for a touch-pad surface 215. Under each discrete “key” 220a to 220c, which has been printed to mimic a key is a membrane bump 225 which restricts the applied force from a key 220a to 220c to a more limited portion of the surface of the touch-pad 215. In this manner, the application of pressure to one of the discrete keys 220a to 220c is transferred to the touch-pad surface 215 in a more controlled and definite manner.

However, as shown, the approach merely mimics an existing keypad to a touch-pad such that the touch-pad replaces the usual array of physical make/break contacts of a traditional keypad or keyboard.

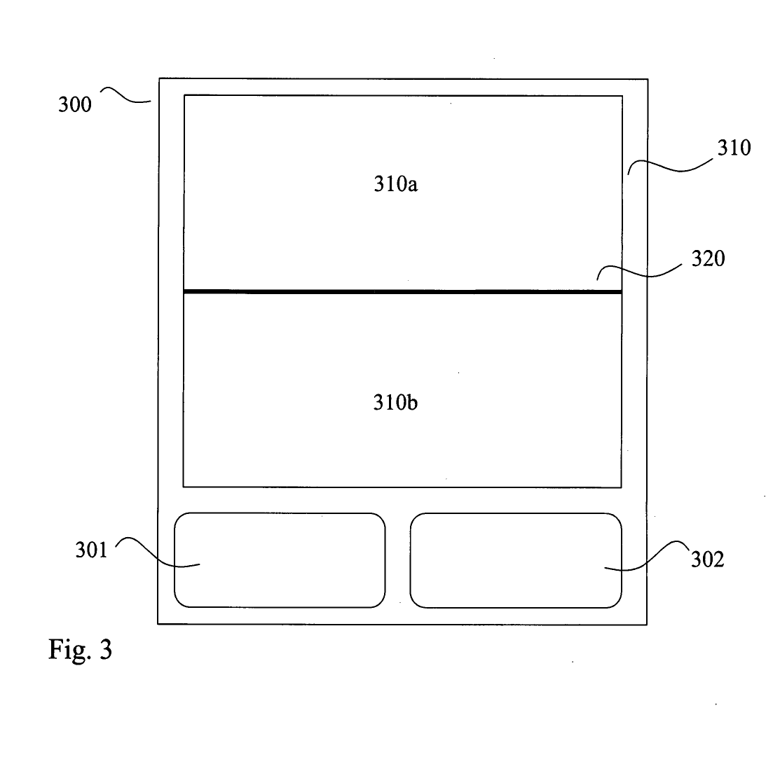

FIG. 3 illustrates a first embodiment of the invention wherein the touch-pad module 300 of an electronic device comprises the normal touch-pad 310, and buttons 301 and 302. However, as shown the touch-pad 310 includes a single surface feature 320, which defines an upper and lower touch-pad area, being 310a and 310b, respectively.

The single surface feature 320 provides a simple tactile differentiator allowing the user to have additional positional information of, for example a finger, relative to the touch-pad. It would also be evident to one skilled in the art that such a differentiator also provides enhanced selection of a function as the user can easily distinguish between one half or the other of the touch-pad, whether the touch-pad is visible or not, and therefore provide for two different actions from a single finger contact being in one half or the other. Equally a user's motion applied to one half or the other is differentiable as having different functions.

The single surface feature 320 presents a surface wherein a user optionally quickly and with little hesitation trace any numeral according to the same rules as used to display them with a seven-segment display such as commonly found in LCD or LED displays. As such the motion of a finger according to the “edges” of the upper and lower touch-pad areas 310a and 310b allows the translation of finger motion to a numeral.

Other embodiments exploiting the two sections of a touch-pad will be evident including the advantage that the interface allows for operation with a single finger, a single toe, a stylus held in the mouth or even a tongue. This provides for increased user data entry in situations wherein the user has a disability or facilitates the use of the added functionality in situations where such interfaces have not been possible today.

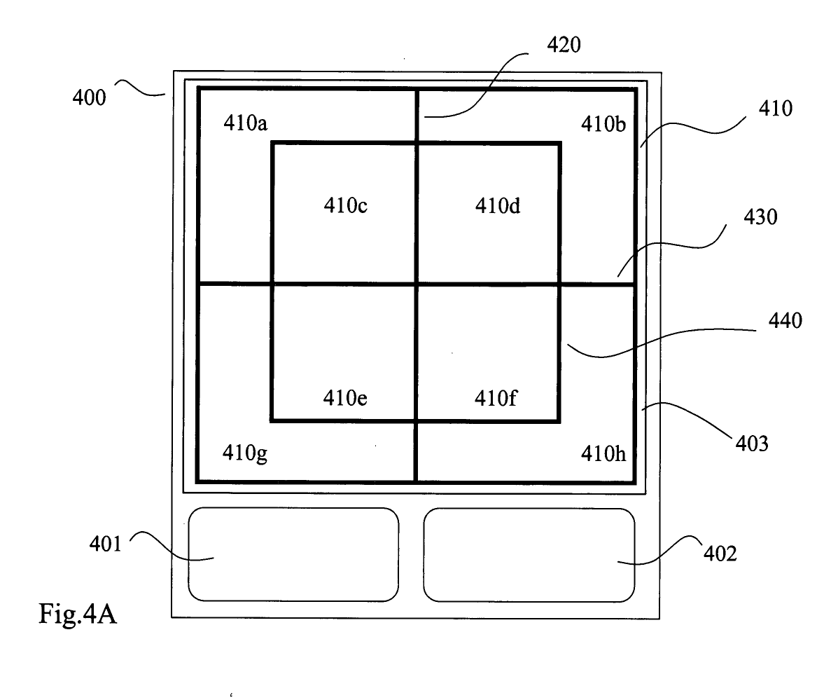

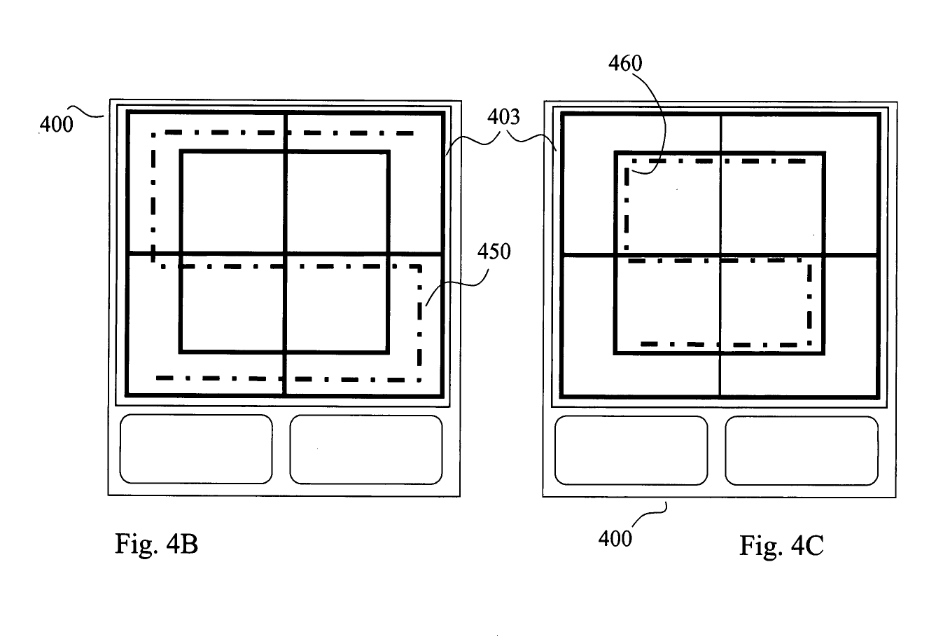

Referring to FIG. 4A, there is shown a second embodiment of the invention, wherein the touch-pad 403 of a user interface element 400 is divided by a different arrangement of surface features 420, 430 and 440 as well as periphery surface feature 410. The conventional touch-pad of a computer comprising touch pad and two buttons is shown as the user interface element 400. The two buttons 401 and 402 provide a similar functionality through activation by a single-click or double-click, as with a computer mouse.

The user interface element 400 has a touch-pad surface 403 that is divided by four surface features 410, 420, 430, and 440. With the sensitivity of the human body these surface features 410 to 440 are provided as, for example, relatively small changes in the surface such as bumps or indents. Alternatively, these surface features comprise a small textured region as opposed to a predominantly smooth touch-pad surface 403.

As shown in the embodiment of FIG. 4A the surface features 410 to 440 result in the surface of the touch-pad 150 being divided into eight identifiable zones 410a to 410h. Without any visual indicator a user would become familiar with the segmented design of the touch-pad surface 403 and be able to place their finger, for example, into one of the specific identifiable zones 410a to 410h of the user interface element 400.

Now referring to FIG. 4B and FIG. 4C, an exemplary embodiment of the segmented touch-pad surface 403 is presented. The placing of surface features 420 to 440 allows a user to enter alphanumeric characters in both upper and lower case with ease.

Considering FIG. 4B, the translational motion of an object, for example a finger, along the first path 450, which includes motion in segments 410b, 410a, 410g, 410e, 410f, and 410h in sequence, is recognized and associated with, for example, an upper case “S”.

Considering FIG. 4C, the translational motion through segments 410d, 410c, 410e, and 410f, including vertical and horizontal motion within segments 410c and 410f, is recognized by a processor in data communication with the touch-pad 403 as, for example, a lower case “s”.

One skilled in the art will appreciate that this association of motions with specific sectors as well as the sequence of sectors allows for a user to enter all upper and lower case characters as well as numeric data from the keypad without recourse to multiple overlays or flexible membranes. Also motion associated with special characters such as “@” and “$” is optionally described simply according to the sectors and motions within specific sectors.

Clearly, the embodiment as shown allows for the user to define and/or modify sequences according to individual preferences, left or right-handedness, disability and so forth. Additionally touch-pad 420 provides for multiple actions such as operating as an array of toggle switches as a finger contact within a specific sector is now distinguishable as being intended to be within one segment of the touch-pad.

Further, it would be evident that the user data entry device can be of any shape, may in fact be hidden from the users view, and can be matched to a three-dimension surface to add further benefits. For example, it would be advantageous if the device could be applied to the reverse surface of a steering wheel allowing a user to access in-car navigation, music players, activate and operate their hands free cellular telephone without recourse to removing their hand or hands from the wheel, without requiring voice recognition or many, many switches on the steering wheel. The device could be on one surface of an arm-rest of a wheelchair allowing the user to control motion and enter text to a speech-generator, or it could be in the surface of a mouse allowing text entry without a keyboard, in the rear surface of a telephone allowing a user to speak and make notes simultaneously, or conference a third party without stopping conversation.

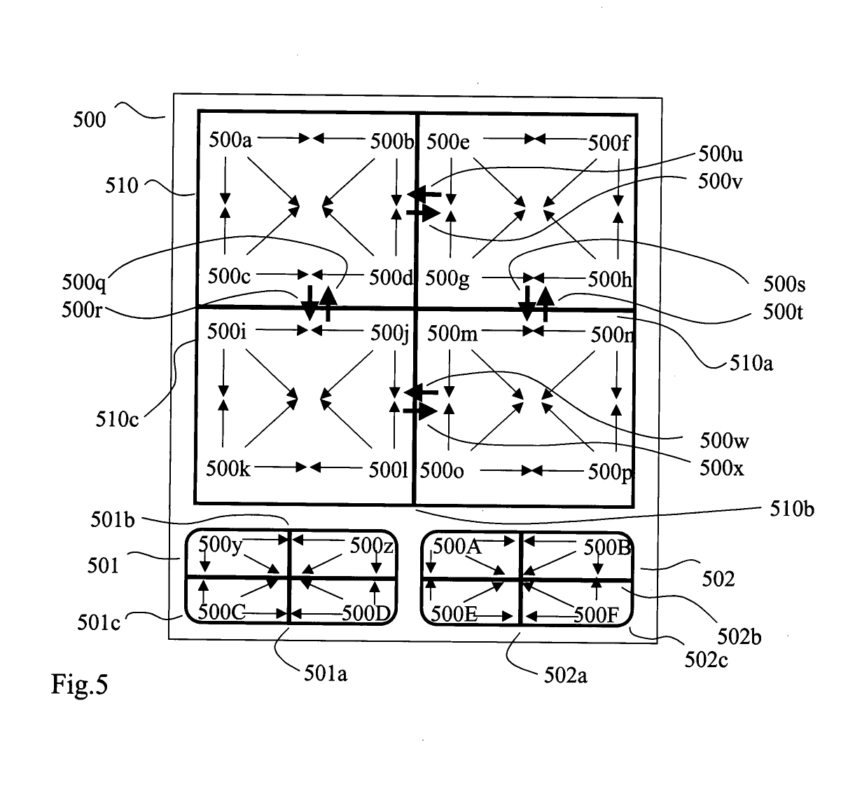

FIG. 5 illustrates a third embodiment of the invention wherein the two buttons 401 and 402 outlined in FIG. 4 for a variant of a typical two-button one-touch-pad are replaced with second and third touch-pads 501 and 502 along with the first touch-pad 510 of the overall touch-pad assembly 500.

As shown, the first touch-pad 510 is defined by the surface feature on its boundary 510c and is divided by two surface features 510a and 510b into four quadrants. The control circuit (not shown) attached to the touch-pad assembly 500 is programmed to detect the location of first contact with an external surface such as a fingertip impressed thereon, to one of the touch pad surfaces 501, 502 and 510, and subsequent direction of motion of the fingertip while in contact therewith. Therefore, considering the first touch-pad 510, which has surface features 510a and 510b, and further considering each corner of a quadrant as an identifiable first touch point and then motion directed subsequently in horizontal or vertical directions then we arrive at the sub-set of motions, hereinafter referred to as strokes, as outlined below.

The result is for each quadrant a sub-set of eight such motions allowing for all 26 characters of the alphabet plus 6 special characters, as shown in the exemplary assignment table below these being “@”, “““, “‘“, “=”, “+”, and “−“.

| | | | |
|---|---|---|---|
| 500 | a | Right | A |
| | | Down | B |
| | b | Left | C |
| | | Down | D |
| | c | Up | E |
| | | Right | F |
| | d | Up | G |
| | | Left | H |
| | e | Right | I |
| | | Down | J |
| | f | Left | K |
| | | Down | L |
| | g | Up | M |
| | | Right | N |
| | h | Up | O |
| | | Left | P |
| | I | Right | O |
| | | Down | R |
| | j | Left | S |
| | | Down | T |
| | k | Up | U |
| | | Right | V |
| | l | Up | W |
| | | Left | X |
| | m | Right | Y |
| | | Down | Z |
| | n | Left | @ |
| | | Down | ″ |
| | o | Up | ′ |
| | | Right | = |
| | p | Up | + |
| | | Left | − |

If we now additionally allow for the recognition of diagonal motion from each initial touch-pad then we arrive at 12 identifiable and distinct strokes per quadrant, or 48 for the first-touch pad 510.

| | | | |
|---|---|---|---|
| 500 | a | Right | A |
| | | Diagonal | 1 |
| | | Down | B |
| | b | Left | C |
| | | Diagonal | 2 |
| | | Down | D |
| | c | Up | E |
| | | Diagonal | 3 |
| | | Right | F |
| | d | Up | G |
| | | Diagonal | 4 |
| | | Left | H |
| | e | Right | I |
| | | Diagonal | 5 |
| | | Down | J |
| | f | Left | K |
| | | Diagonal | 6 |
| | | Down | L |
| | g | Up | M |
| | | Diagonal | 7 |
| | | Right | N |
| | h | Up | O |
| | | Diagonal | 8 |
| | | Left | P |
| | I | Right | Q |
| | | Diagonal | 9 |
| | | Down | R |
| | j | Left | S |
| | | Diagonal | 0 |
| | | Down | T |
| | k | Up | U |
| | | Diagonal | # |
| | | Right | V |
| | l | Up | W |
| | | Diagonal | $ |
| | | Left | X |
| | m | Right | Y |
| | | Diagonal | % |
| | | Down | Z |
| | n | Left | @ |
| | | Diagonal | & |
| | | Down | ″ |
| | o | Up | ′ |
| | | Diagonal | * |
| | | Right | = |
| | p | Up | + |
| | | Diagonal | ! |
| | | Left | − |

With this mapping the user is now able to enter all 26 characters, 10 numerals, and “#”, “$”, “%”, “@”, “&“, ““”, “‘“, “*”, “=”, “+”, “!”, and “−“, for example.

Similarly, if the second touch-pad surface 501 has three surface features 501a to 501c, the user can access a further 12 strokes. This is shown as only twelve by considering the second touch-pad surface 501 to be small and as such the surface features 501a to 501c allowing the user to resolve the different comers and diagonal motions with some limits. Similarly the third touch-pad surface 502 is shown with surface features 502a to 502c giving a further 12 identified strokes. In this manner the three touch-pads 501, 502, and 510 as shown result in 72 different and distinct” strokes by a user. This allows for all 26 characters, ten numerals, 30 standard specials for a normal keyboard, and the additional keys of CAPS LOCK, ALT, TAB, CTRL, SHIFT and ENTER. Essentially the complete standard keyboard has been mapped to a simple touch-sensitive pad.

Further the mapping of alphanumeric keys to the different strokes is flexible such that it is optionally user selectable, defined by a language selected, the application in operation, or numerous other criteria. Hence, a user operating in English might assign the vowels to the center, and most common consonants to the corners, whereas:
User A assigns the strokes to the Cyrillic alphabet;
User B assigns common mathematical symbols such as sum “Σ”, square root “√”, not equal “≈”, and “greater than or equal “≧” in editing their mathematics thesis;
User C assigns Greek characters such as lower case alpha “α”, beta “β”, delta “δ”, upper case delta “Δ”, and upper case omega “Ω”; and
User D assigns them to “fire”, “bomb”, “duck”, “run”, “stop”, “walk” in their online multi-player game as they play on their cellular telephone.

Association of the touch-pad segments and finger motions is assignable in either a fixed or dynamic manner. The resulting actions are optionally textual entry, drawing, and numeric entry, and control functions for a game, machine or other system. A user by virtue of being presented with cues through touch onto the touch-pad adapts and learns to use such a touch-pad irrespective of its physical orientation to the user. As such the approach is adaptable to touch-pads of arbitrary shape and contour, with surface features determined by application, and are preferably placed according to optimum ergonomic use by the operator for that application.

In this manner the invention allows for the data entry device to really exploit the capabilities of the human mind to associate abstract concepts in a spatial manner, and leverage the incredible sensitivity of the human skin to provide tactile feedback such that a single small entry device can be exploited for multiple entry formats and multiple characters.

The provision of tactile feedback to the user allows the touch-pad as outlined in the embodiments to be used by users with visual disabilities, visual impairments, and dyslexia. It will also be evident that the touch-pad does not have to be visible to even a visually able user allowing the touch-pad to be positioned onto the rear surface of electronics devices such as cellular telephones, PDAs, and MP3 players as well as onto a wide range of objects such as steering wheels, joysticks, doorknobs, handles, and grips. In some instances therefore the touch-pad allows for security credential entry directly through the normal handle or grip rather than an additional discreet keyboard.

As described in the embodiments user selected input data signals are generated to an electronic device in response to the users motion of their finger or fingertip when in contact with the surface of a touch-pad. It will be evident that the invention is compatible with a variety of touch-pad formats that will provide the required functionality, including electrical contact, membrane switches, capacitance based touch-pads, thermally sensitive pads and optical position detectors. It will be further evident that the approach allows for the touch-pad to be operated with other parts of the human body, such as toe, tongue, and nose, as well as other implementations such as a style held between toes or within the mouth. All provide the tactile feedback to the user and allow the data entry device to be used by individuals with a wide range of disabilities, the touch-pad being further adaptable to the requirements of the user.

Numerous other embodiments may be envisaged without departing from the spirit or scope of the invention.

What is claimed is:

1. An apparatus for providing data input signals to an electronic device comprising;
a pad for receiving a user selected input signal,
a surface element, the surface element being part of the surface of the pad, the surface element providing a distinguishable feedback to the user;
the pad generating the data input signal in response to the user input signal; the user input signal being at least an object's position in relation to the surface of the pad; wherein the object is controlled by a user.

2. An apparatus according to claim 1 wherein;
the pad is a touch-pad, the touch-pad sensing the object's position as controlled by the user.

3. An apparatus according claim 1 wherein;
the pad is a thermally sensitive pad, the thermally sensitive pad sensing the object's position based upon a localized temperature change as controlled by the user.

4. An apparatus according to claim 1 wherein;
the pad is a position detector, the position detector sensing the object's position as controlled by the user.

5. An apparatus according to claim 1 wherein;
the distinguishable feedback to the user improves the user's spatial resolution in the placement of the object.

6. An apparatus according to claim 1 wherein;
the distinguishable feedback is tactile feedback.

7. An apparatus according to claim 1 wherein;
the distinguishable feedback is visual feedback.

8. An apparatus according to claim 1 wherein;
the surface feature is a surface texture.

9. An apparatus according to claim 1 wherein;
the surface feature is the appearance of the surface feature relative to the surface of the touch-pad.

10. An apparatus according to claim 1 wherein;
the surface feature is a perturbation of the surface of the touch-pad.

11. An apparatus according to claim 10 wherein;
the perturbation of the surface is an indentation into the surface of the touch-pad.

12. An apparatus according to claim 10 wherein;
the perturbation of the surface is a protrusion from the surface of the touch-pad.

13. An apparatus for data input according to claim 1 comprising;
a processor for providing an appearance control signal, the appearance control signal generated in dependence upon the data input signal generated;
wherein the surface of the pad supports a change in appearance in response to receiving the appearance control signal.

14. An apparatus for data input according to claim 1 wherein;
the surface of the pad has a change in appearance from the surface adjacent to one side of the surface feature to the surface adjacent the other side of the surface feature.

15. An apparatus according to claim 1 wherein;
the surface of the pad other than the surface feature is planar.

16. An apparatus for data input according to claim 1 wherein;
the surface of the pad other than the surface feature is a portion of a spherical surface.

17. An apparatus for data input according to claim 1 wherein;
the surface of the pad is formed to in accordance with the surface profile of the electronic device.

18. An apparatus for data input according to claim 1 wherein;
the surface of the pad is formed to provide an ergonomic interface for the user as part of the overall electronic device.

19. An apparatus for data input according to claim 1 wherein;
sensing an object's position comprising the sensing of at least one of a finger, a thumb, a toe, a tongue, and a stylus when placed in at least one of contact and proximity with the pad.

20. An apparatus for data input according to claim 1 wherein;
the electronic device uses the sensed position to select a function;
the function based upon the sensed position and a status of the electronic device.

21. An apparatus for data input according to claim 20 wherein;
the function for execution being executed is communicated to at least one of the electronic device, a second electronic device, and a machine.

22. An apparatus for data input according to claim 20 wherein;
the communication is by at least one of direct electrical coupling, infrared transmission,
wireless transmission, electronic transmission via a network and an electronic storage medium.

23. An apparatus for data input according to claim 1 wherein;
the electronic device uses the sensed position of the object to provide motional input;
the motional input based upon the sensed position information and a status of the electronic device.

24. An apparatus for data input according to claim 23 wherein;
the motional input is used for the at least one of moving a cursor on a display, drawing an object within a software application, controlling the operation of a machine, and controlling the motion of a machine.

25. An apparatus for data input according to claim 1 wherein;
the electronic device uses the sensed position of the object to select a numerical value;
the numerical value based upon the sensed position and a status of the electronic device.

26. An apparatus for data input according to claim 1 wherein;
the electronic device uses the sensed position of the object to select an alphanumeric character;
the alphanumeric value based upon the sensed position and a status of the electronic device.

27. An apparatus for data input according to claim 1 wherein;
the electronic device uses the sensed position of the object to select a character;
the character based upon the sensed position and a status of the electronic device.

28. A method for entering data to an electronic device comprising;
providing a pad for receiving a user input signal,
providing a surface element, the surface element being part of the surface of the pad, the surface element providing a distinguishable feedback to the user;
generating the data input signal in response to the user input signal; the user input signal being at least an object's position in relation to the surface of the pad; wherein
the object is controlled by a user.

29. A method for entering data according to claim 28 wherein;
providing the pad is by providing a touch-pad, the touch-pad sensing the object's position as controlled by the user.

30. A method for entering data according claim 28 wherein;
providing the pad is by providing a thermally sensitive pad, the thermally sensitive pad sensing the object's position based upon a localized temperature change as controlled by the user.

31. A method for entering data according to claim 28 wherein;
providing the pad is by providing a position detector, the position detector sensing the object's position as controlled by the user.

32. A method for entering data according to claim 28 wherein;
providing the distinguishable feedback to the user improves the user's spatial resolution in the placement of the object.

33. A method for entering data according to claim 1 wherein;
providing a surface feature is achieved by a change in surface texture.

34. A method for entering data according to claim 28 wherein;
providing a surface feature is achieved by a change in the visual appearance of the surface feature relative to the surface of the touch-pad.

35. A method for entering data according to claim 28 wherein;
providing a surface feature is achieved through a perturbation of the surface of the touch-pad.

36. A method for entering data according to claim 35 wherein;
providing the perturbation of the surface is obtained by the provision of an indentation into the surface of the touch-pad.

37. A method for entering data according to claim 35 wherein;
providing the perturbation of the surface is obtained by the provision of a protrusion from the surface of the touch-pad.

38. A method for entering data according to claim 28 wherein;
providing the surface of the touch-pad includes providing a change in visual appearance from the surface adjacent to one side of the surface feature to the surface adjacent the other side of the surface feature.

39. A method for entering data according to claim 28 wherein;
providing the surface of the pad other the surface feature is at least one of providing a planar surface, a portion of a spherical surface, a surface matched to the surface profile of the electronic device, and a surface formed to provide an ergonomic surface as part of the electronic device.

40. A method for entering data according to claim 28 wherein;
sensing an object's position includes the sensing of at least one of a finger, a thumb, a toe, a tongue, and a stylus when placed in contact or proximity with the touch-pad.

41. A method for entering data according to claim 28 wherein;
sensing an object's position includes the selection of a function;
the function based upon the sensed position and a status of the electronic device.

42. A method for entering data according to claim 41 wherein;
the function for execution being executed is communicated to at least one of the electronic device, a second electronic device, and a machine.

43. A method for entering data according to claim 42 wherein;
providing communication is by at least one of direct electrical coupling, infrared transmission, wireless transmission, electronic transmission via a network and an electronic storage medium.

44. A method for entering data according to claim 28 wherein;
sensing an object's position includes providing motional input;
the provided motional input based upon the sensed position information and a status of the electronic device.

45. A method for entering data according to claim 44 wherein;
providing motional input results in at least one of moving a cursor on a display, drawing an object within a software application, controlling the operation of a machine, and controlling the motion of a machine.

46. A method for entering data according to claim 28 wherein;
sensing an object's position includes the selection of a numerical value; the numerical value based upon the sensed position and a status of the electronic device.

47. A method for entering data according to claim 28 wherein;
sensing an object's position includes the selection of an alphanumeric character; the alphanumeric value based upon the sensed position and a status of the electronic device.

48. A method for entering data according to claim 28 wherein;
sensing an object's position includes the selection of a character;
the character based upon the sensed position and a status of the electronic device.
